(19) United States
(12) Patent Application Publication
(10) Pub. No.: US 2003/0028426 A1
(43) Pub. Date: Feb. 6, 2003

(54) Discount processing system

(75) Inventors: Dwip N. Banerjee, Austin, TX (US); Rabindranath Dutta, Austin, TX (US)

Correspondence Address: Robert V. Wilder, Attorney At Law, 4235 Kingsburg Drive, Round Rock, TX, 78681, US

(73) Assignee: International Business Machines Corporation, Armonk, NY

(21) Appl. No.: 09/920,456

(22) Filed: Aug. 2, 2001

(51) Int. Cl. G06F 17/60

(52) U.S. Cl. 705/14

(57) ABSTRACT

A method and implementing system are provided in which a user processing device, which includes input means and display means, is selectively operable to enable users to scan or otherwise identify products being offered for sale or lease. When a selected product is scanned or otherwise identified by a user input, the product code is transmitted by the processing device to a server which, in turn, provides a listing of all available coupons and other special offers available for the identified product or type of product. The user is then enable to select, from among the displayed coupons, which coupons the user wishes to redeem. The listing is displayed on the user's processing device and the user is enabled to select the particular coupon or offer desired. In a first example, the user's processing device is a portable device while in another example, the user's processing device is in the form of a kiosk. Selected coupons or offers for a number of products are electronically stored and accessed when the user is ready to check-out at a store check-out or exit terminal. The user provides identification to the check-out system such as by scanning a customer identification (ID) card at a check-out terminal. The scanned customer ID is used to access the stored account of customer-selected coupons and appropriate discounts are entered for items that are purchased or leased. All related store, customer and manufacturer product and coupon accounts are automatically updated when the purchase or lease transaction is completed.

### FIELD OF THE INVENTION

The present invention relates generally to information processing systems and more particularly to a methodology and implementation for electronically processing paperless coupons related to items being offered for sale or lease.

### BACKGROUND OF THE INVENTION

The use of paper coupons in providing a means for discounting products is widespread and well accepted. Typically, manufacturers of products or retail store managers, by mail, newspaper, magazine or otherwise, cause selected coupons to be delivered to potential buyers of the items related to the coupons. The potential purchasers then take the coupons to a retail store at which the coupons may be redeemed to provide a discount to the purchaser for purchasing the specified item.

Although this paper-based coupon processing system is still very popular, there are many disadvantages to the paper-based system and many of the disadvantages of the paper-based system are obviated by the use of an electronic coupon processing systems. Unfortunately, currently available electronic coupon processing systems are relatively limited and do not provide potential purchasers a convenient way of exercising particular discounts on products selected by the purchaser. In many cases, a consumer or purchaser is inundated with coupons covering a great many items when the consumer is interested in purchasing only a particular item or type of item. Rather than navigate through a mountain of coupons being offered for unwanted items, many consumers simply do not participate in the coupon redemption process.

Thus there is a need for an improved methodology and implementing system for efficiently processing electronic coupons.

### SUMMARY OF THE INVENTION

A method and implementing system are provided in which a user processing device, which includes input means and display means, is selectively operable to enable users to scan or otherwise identify products being offered for sale or lease. When a selected product is scanned or otherwise identified by a user input, the product code is transmitted by the processing device to a server which, in turn, provides a listing of all available coupons and other special offers available for the identified product or type of product. The user is then enable to select, from among the displayed coupons, which coupons the user wishes to redeem. The listing is displayed on the user's processing device and the user is enabled to select the particular coupon or offer desired. In a first example, the user's processing device is a portable device while in another example, the user's processing device is in the form of a kiosk. Selected coupons or offers for a number of products are electronically stored and accessed when the user is ready to check-out at a store check-out or exit terminal. The user provides identification to the check-out system such as by scanning a customer identification (ID) card at a check-out terminal. The scanned customer ID is used to access the stored account of customer-selected coupons and appropriate discounts are entered for items that are purchased or leased. All related store, customer and manufacturer product and coupon accounts are automatically updated when the purchase or lease transaction is completed.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an exemplary embodiment of an interconnected electronic coupon processing system;

FIG. 2 is an exemplary block diagram of several of the major components of the processing system shown in FIG. 1;

FIG. 3 is a schematic diagram illustrating the major components and modules of the user processing device which is used in the exemplary embodiment of the present invention;

FIG. 4 is an example of an E-coupon server organization;

FIG. 5 is an exemplary illustration of an overall flow chart in accordance with the present invention;

FIG. 6 is a flow chart illustrating an exemplary methodology which may be implemented in an E-coupon retrieval process; and

FIG. 7 is a flow chart illustrating an exemplary methodology which may be implemented to provide an E-coupon redemption process in connection with the present invention.

### DETAILED DESCRIPTION

The various methods discussed herein may be implemented within a typical computer-related system which may include one or more computer systems or servers being operated in combination over an interconnection network. The disclosed methodology may also be implemented using enhanced wireless technology to perform any or all of the functions described.

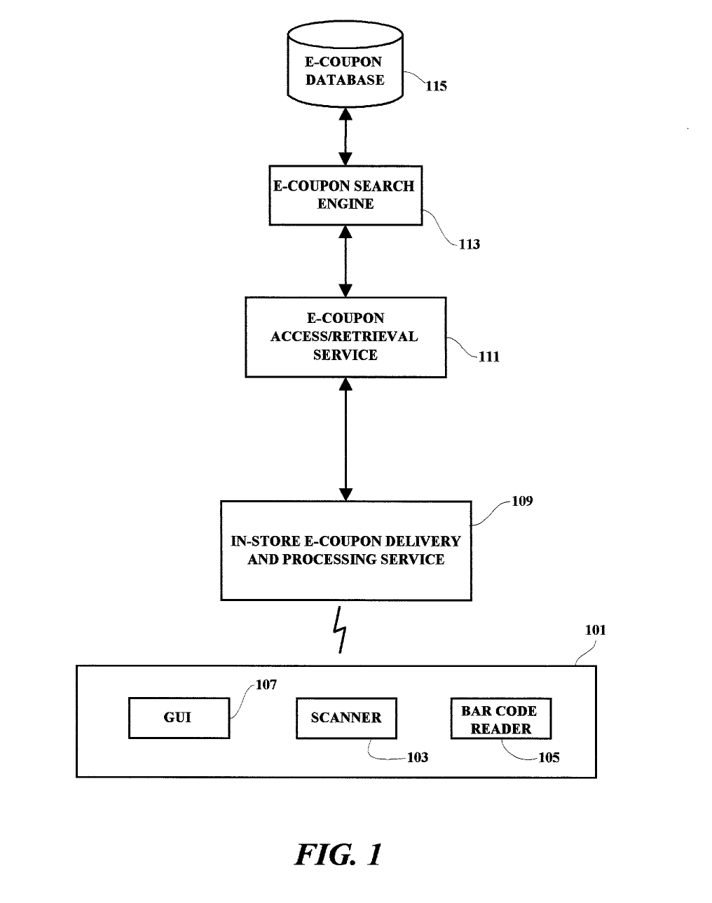

In FIG. 1, there is shown a user processing device 101, which is arranged to employ scanning means 103 in combination, for example, with a bar code reader 105 to scan a product code on a user-selected product. The processing device may be comprised of a cellular phone or other handheld portable device which is enhanced to include a scanning device 103, a code reader 105 and a graphical user interface (GUI) 107 as hereinafter described. The GUI 107 is used to transmit a scanned product code to a store server 109.

Wireless technology is beneficially used in the example for communications between the user device 101 and the store server 109. Wireless technology may also be implemented in any of the other interconnections illustrated.

In the example illustrated in FIG. 1, the display store server 109 is selectively connected through an interconnection network to an E-coupon access and retrieval service server 111. The E-coupon server 111 is arranged to work through a E-coupon search engine 113 to search an E-coupon database 115 for coupons related to a user-selected product, i.e. a product for which the user has scanned the product code into the user processing device 101. The store server 109 selectively connects to a one or more E-coupon retrieval services 111 through an interconnection network such as, for example, the Internet.

In general, the implementing server units include computer systems which may employ a plurality of processors in a multi-bus system in a network of similar systems. The servers generally include storage and memory systems as well as input and output systems. However, since the server workstations or computer systems used in practicing the present invention in an exemplary embodiment, are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

In the exemplary embodiment herein disclosed, although reference is made to the “purchase” of items and the use of discount “coupons” related to the items being “offered for sale” and “purchased”, it is understood that the coupon processing system also applies to discounts which are offered on items which are rented, licensed or leased, including but not limited to the license, lease or rental of media products such as computer programs, movies and videos, and/or audio media. Moreover, the term “coupon” as used herein, means not only a specific discount for a given product but also refers generically to discount programs of any kind including discounts given by a manufacturer or a retailer for a group of products or for a package of products or for special limited time promotions.

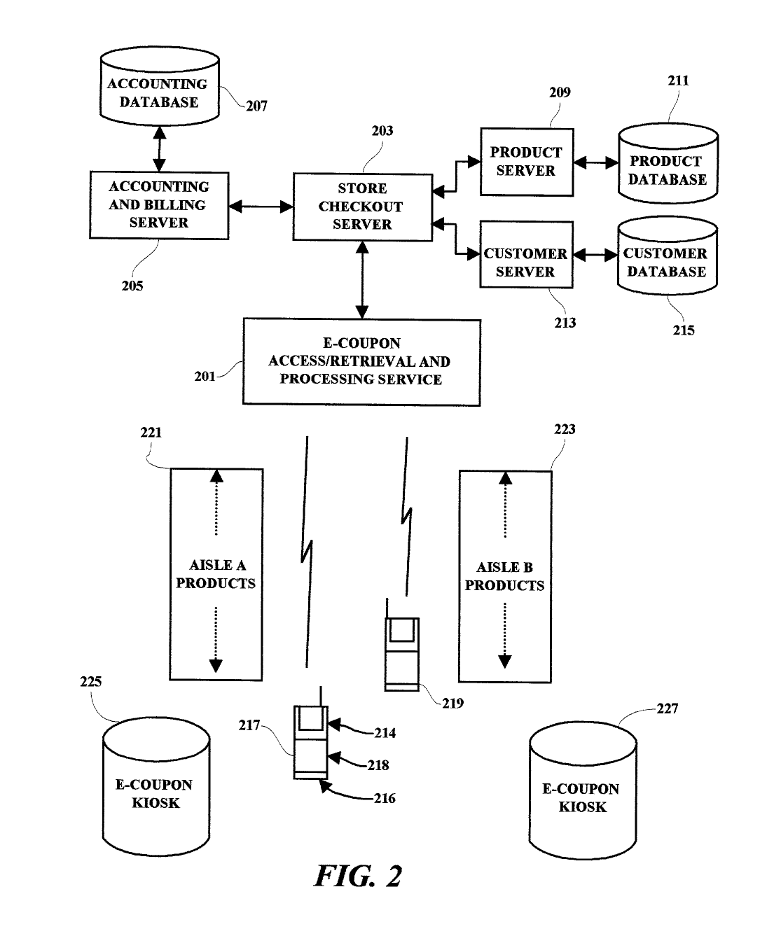

In FIG. 2, there is shown an E-coupon access retrieval and processing (ARP) service 201 which is arranged to be coupled with personal or store-provided hand-held processing devices 217 and 219 which are enabled with a scanning function as hereinbefore discussed. The E-coupon coupon ARP service 201 of FIG. 2 uses components within the E-coupon access and retrieval service server 111 and the in-store E-coupon delivery and processing service server 109 as shown in FIG. 1. The ARP service 201 is arranged to communicate with a store checkout server 203. The store checkout server 203 is further coupled to product and customer servers 209 and 213, respectively, which are, in turn, connected to product and customer databases 211 and 215, respectively. The checkout server 203 is also connected to the store accounting system which, in the present example, includes an accounting and billing server 205 coupled to an accounting database 207. The product, customer and accounting functions are coupled to the checkout server 203 in order to enable an automatic updating of the accounting for the store inventory and coupon offerings each time a product is purchased using a coupon. The various databases are useful in tracking coupon usage for all customers. This function is helpful for example where coupon offers are limited and applicable to only a certain number of purchases per customer per predetermined period of time. The product database is used to monitor the number of products sold using a processed coupon. This information is useful in product marketing and also in determining when a store has used up its allotted number of coupons for a given promotion. The accounting and billing server maintains appropriate accounting for the discounts given with the E-coupons, i.e. which manufacturer or store account gets charged for the given discount associated with an E-coupon which is redeemed by a customer. In the exemplary embodiment, all of the noted databases are updated automatically upon the completion of a sale in which an E-coupon has been redeemed.

In FIG. 2, as noted earlier, user or customer hand-held processing devices 217 and 219 include a scanning section 216 (including the scanner 103 and bar code reader 105), a user input section 218 and a user display means 214. The display 214 is used to display the GUI 107, and the input section 218 is used to enable a user to select from various options presented on the displayed GUI. In the present example, after a user has scanned in a product code from a product on aisle A 221 or aisle B 223 for example, the display 214 of the processing device 217 will show one or more coupons or discount offers which are applicable to the scanned product. The product code scanned by the customer may be on the product itself or in the area proximate to the product such as the aisle shelving edges. Referencing the displayed GUI, the user will then indicate which, if any, of the offers the user wishes to select by hitting a designated key or button on the input section 218. When a user selects a particular coupon, that information is stored in a product database which is associated with the particular customer or user. The product database is maintained at the store level server and may also be maintained in local storage in the user's processing device.

E-coupon kiosks, such as kiosks 225 and 227, may also be placed at convenient locations in a store to provide an alternative mechanism by which a customer may use the disclosed e-coupon methodology. For example, an e-coupon kiosk 225 would be comprised of an input mechanism such as a keyboard, and/or a mouse or other pointing device. The kiosk 225 also contains a display device for presenting information to a customer using the kiosk. The customer is enabled to input the desired products (by name, type or product number) and retrieve related coupons associated with the product. The overall function of the kiosk corresponds to the functionality of the portable or wireless customer processing device, e.g. 217. Although the kiosk will typically be used by using the keyboard or mouse/menu process to select products and determine coupon discounts, the kiosk may also have a scanning mechanism as an input device to scan a product code if a customer already has the product with the code on the product, and wishes to scan the code at the kiosk to determine if any coupons are available before checkout.

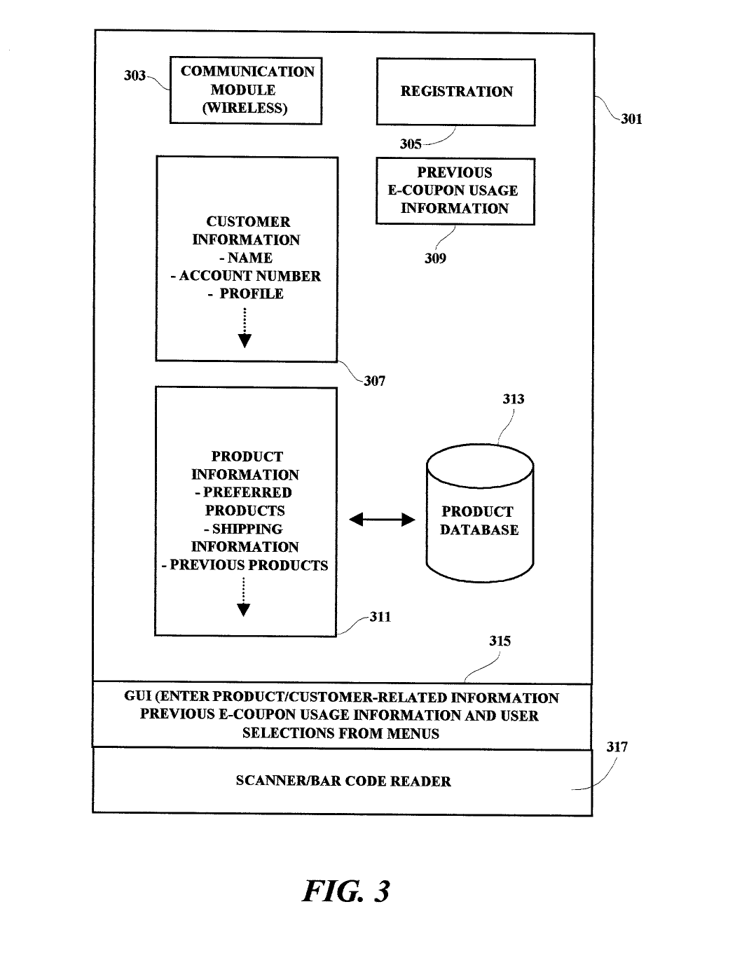

In FIG. 3, several of the components of the user portable processing device 301 are illustrated. As shown, the processing device 301 includes a communication module 303 which in the present example enables a wireless communication with an ARP server system. Also included is a registration module 305, and a customer information module 307. Information is also processed with regard to preferred products and shipping information, etc. 311, and the purchased and/or queried product information may also be maintained locally in a product database 313 maintained in the processing device 301. In a general sense, the customer scans a product code and communicates that information to the ARP to retrieve associated coupons. The product information 311 and product database 313 represent a mechanism to optimize the process by storing the customer's preferences and previous usage patterns to enable the retrieval of e-coupon information with minimal customer data entry. As noted earlier, the user or customer processing device 301 also includes GUI software 315 and scanner/bar code reader software 317.

In connection with the present invention, the GUI and Input sections enable a user to input the user's preferences for products and the identity of products most often purchased, in addition to enabling a user selection from a displayed menu. The preferred and most used product information may be used in a distinct general retrieval mode in which a customer may, without scanning a particular product, invoke a general listing of current coupons available for the user's favorite or most used products as identified in the user's product database 313. The customer may invoke the general retrieval mode upon entering a store and before scanning any specific product code. For example, if a user is shopping only for toothpaste, ice cream and milk, and wishes to know which brands of those products have the best discounted price available at the time the user is shopping, the user would input toothpaste, ice cream and milk into the user device without designating a particular brand. Upon initiating a general retrieval mode from the displayed GUI, the user's processing device would upload only the particular items of interest which have been input by the user, i.e. toothpaste, ice cream and milk, and the coupon server would send all currently available coupon or other promotional offers to the user's processing device to be displayed to the user. The user is then able to select from the coupons presented, pick up the designated items and go to the checkout terminal without being inundated with coupon offers which are of no immediate interest to the user.

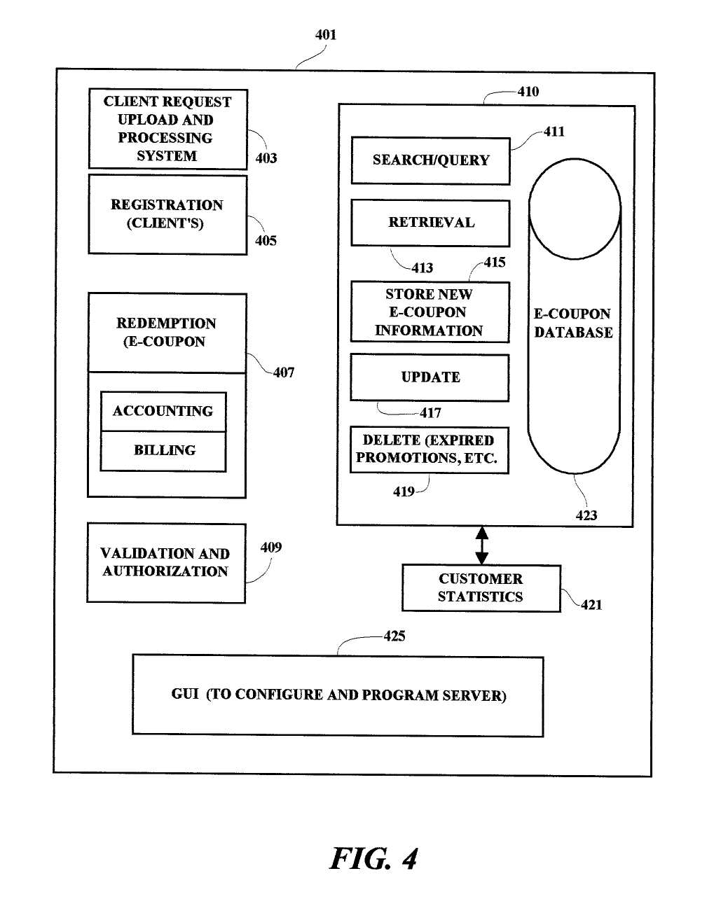

In FIG. 4, there is presented the E-coupon server organization for the in-store E-coupon server 401 (corresponding to server 109 in FIG. 1). As shown, the E-coupon server includes software modules for accomplishing client request uploads and processing 403, client or user registration 405 and validation and authorization 409. Also included is a coupon redemption module 407 which includes accounting and billing update sections. The server organization also includes a customer statistics section 421 which is coupled to a server services section 410. The customer statistics are stored on a store-by-store basis such that information is available to determine how well certain product promotions are doing in different parts of the country by location, customer age, customer income, etc. That information may be used in future promotions in order to better target the e-coupons to accomplish the purpose of a future product promotion.

The server services section 410 includes code for performing functions and services related to the coupon processing operation. Such services include search/query 411, retrieval 413, storage of new E-coupon information 415, update 417 and delete 419 functions. Also shown is the E-coupon database 423. A GUI is also included in the server organization to enable the server to be configured and programmed.

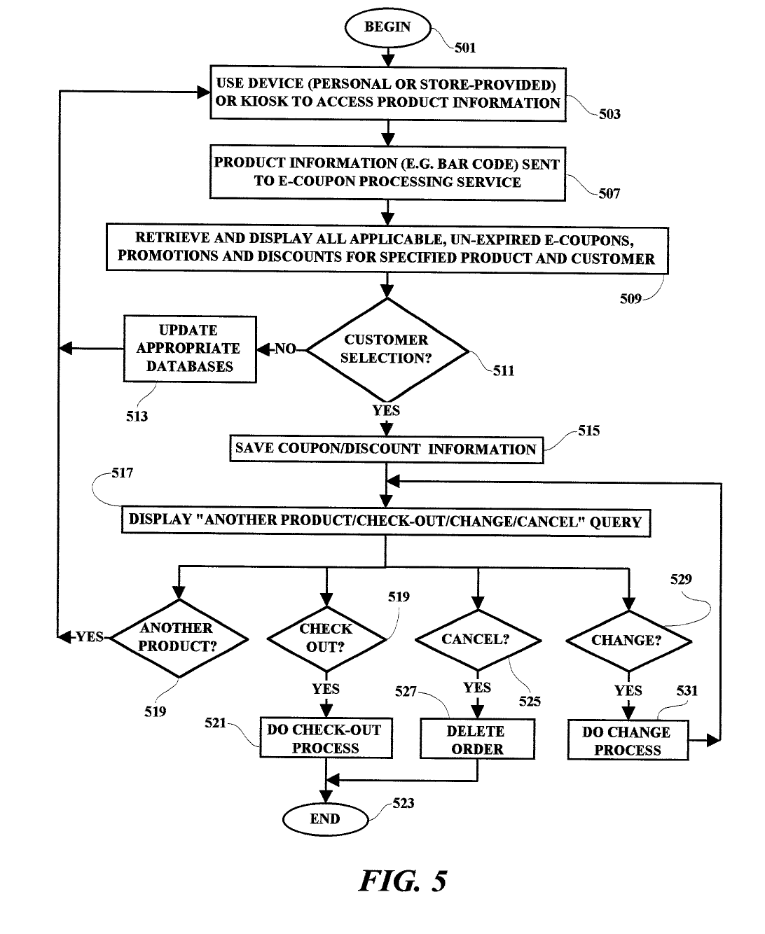

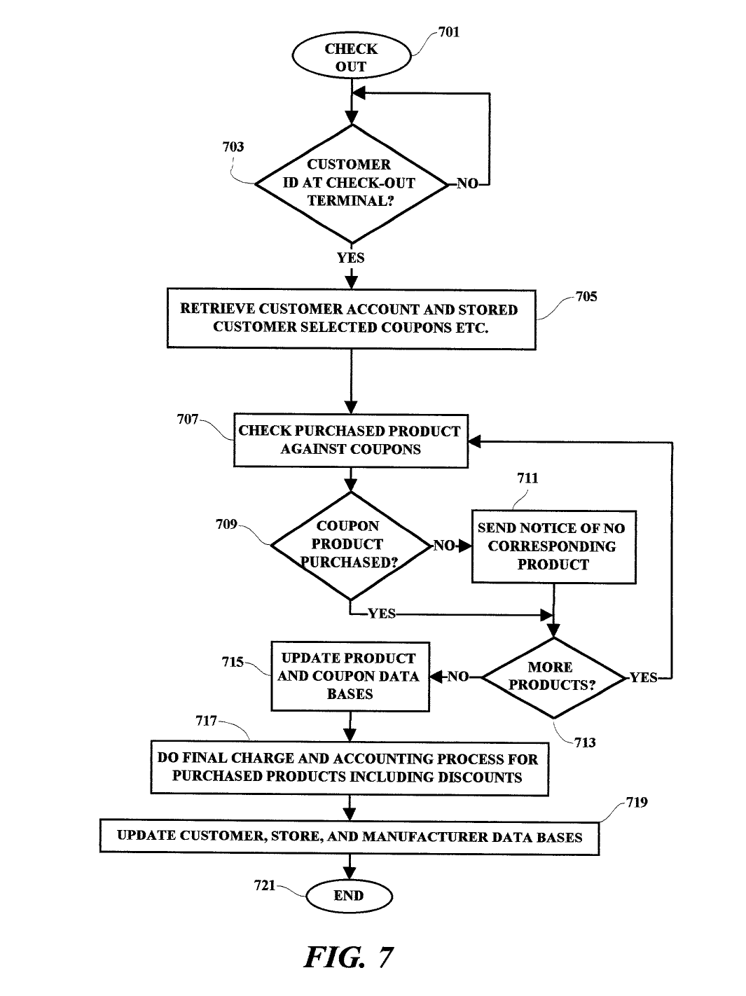

The flow chart illustrated in FIG. 5 shows an exemplary operation of the disclosed coupon processing system. It should be noted that the terms “user”, “consumer” and “customer” all refer to a store customer using the disclosed user processing device in connection with selecting and redeeming E-coupons. Further, as used herein, a customer or user “processing device” refers to and includes either a portable device such as device 217 or a kiosk such as 225. As shown in FIG. 5, the process begins 501 when a customer enters a participating store or outlet and uses 503 the processing device, e.g. device 217, or kiosk 225, to scan or otherwise input a product identification code from a product of interest to obtain product information concerning currently available coupon and other discounts. The scanned product code is transmitted from the processing device to the E-coupon processing service 507 which retrieves all applicable product information 509 from a product database and sends that information to the user processing device (either portable device or in-store kiosk) for display to the user. Next, if the customer uses the processing device 217 and selects 511 one of the available coupon offers being displayed, the selected coupon and product information is saved 515 in a file associated with the particular customer. In the present example, that information is saved in the store server memory although it could also be saved in the processing device memory for later upload as a batch file with other selected product information to the store server at checkout time. If the customer does not make a selection 511, then monitoring databases are updated 513 and the process returns to await the next product scan. The databases that are updated 513 may include, for example, customer inquiry databases which track how often particular products are scanned by potential customers. After information concerning a scanned product are saved 515, a screen is presented on the processing device display GUI to enable the customer to select to scan another product, check-out, change the saved product information or cancel the saved product information 517. If the customer chooses to scan another product 519 the process returns to await the next scan 503. If the customer cancels the saved product information 525, the pending order is deleted 527 and the processing ends 523. If the customer chooses to change the pending order 529, a change process (not shown) is invoked to enable the user to make the desired changes to the saved product information and then return to the selection display 517. If the customer chooses to check-out 519, the check-out process (as illustrated in FIG. 7) is invoked 521 after which the process ends 523.

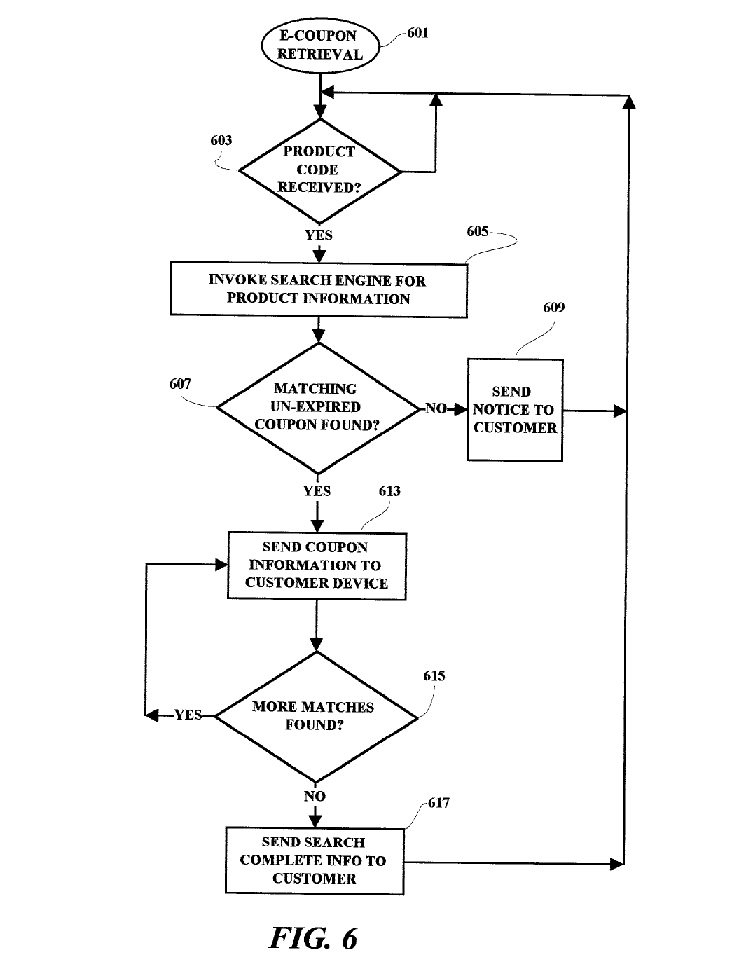

In FIG. 6, the E-coupon retrieval function 601 is illustrated. When a product code is scanned and transmitted by a user, and received 603 by the E-coupon processing service 201, a search engine is invoked 605 to search for coupon and other promotional information concerning the identified product. As matching un-expired coupons are found 607, the relevant information is sent 613 to the customer processing device and displayed to the customer. If no matching un-expired coupons are found for the scanned product 607, information is sent back to the processing device 609 and displayed to the customer to inform the customer that no matching coupons were found. The search process is continued 615 until all matching coupon information related to the scanned product has been found and sent to the customer's processing device, at which time a “search complete” signal is sent 617 to the customer's device to indicate that the displayed results are complete for the scanned product. The process then returns to await input of another product code from the customer.

As an alternative to displaying only coupons related to a particular product scanned, the search service may be programmed to search for and return all coupons related to the selected type or genus of product. Thus a scan of a particular product would return, for user selection, coupon offers related to competing products as well as the particular selected product.

In FIG. 7, an exemplary check-out process 701 is illustrated. As shown, when it is determined that a particular customer is at a check-out terminal 703, that customer's product selections and related selected coupons are retrieved from memory by the check-out server. It is determined that the customer is at a check-out terminal, for example, when the customer swipes a customer account card through a check-out card reader. As each product purchased by the customer is scanned at the check-out terminal, it is compared against the stored selected product coupons 707. When it is determined that a coupon has been selected but no corresponding product has been purchased 709, then a notice is sent 711 to a check-out display to inform a checker and/or customer that the particular coupon for which there is no corresponding product will not be discounted from the customer's total charges. When all of the selected products have been scanned 713, the product and coupon databases are updated 715 and a final charge and accounting process is invoked 717 to finalize the customer's total charges. At that time, appropriate allocations for redeemed coupons are determined and applied according to existing contracts between stores and manufacturers, the customer, store and manufacturer databases are updated 719 for the products purchased and the coupons redeemed, and the processing is ended 721. Both the local stores and the manufacturers are enabled to maintain statistics of customer usage of e-coupons as they deem appropriate.

Within the scope of the present invention there are many optional alternative methods of implementation. For example, the product and coupon databases may be maintained at the store server, or they may be maintained at a manufacturer's server and accessed by the store server over an interconnection network such as the Internet, on a real time basis whenever a customer scans in a product code with a scanner or other input device.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing discounts to customers for products being offered to said customers, said method comprising:
entering product information into a customer processing device, said product information being sufficient to identify a selected product;
transmitting said product information from said customer processing device to a server, said server being responsive to a receipt of said product information for determining discount information, said discount information being related to discounts which are available for said selected product; and
transmitting said discount information from said server to said customer processing device.

2. The method as set forth in claim 1 wherein said product information is entered into said customer processing device manually by said customer.

3. The method as set forth in claim 2 where said product information is entered by said customer at a discount kiosk station located in a store in which said products may be acquired by said customer.

4. The method as set forth in claim 1 wherein said product information is represented by machine readable coded indicia, said machine readable coded indicia being placed proximate to said selected product, said entering being accomplished by scanning said machine readable coded indicia by said customer processing device.

5. The method as set forth in claim 1 wherein said customer processing device is a wireless device.

6. The method as set forth in claim 1 and further including: displaying said discount information on a display screen of said customer processing device.

7. The method as set forth in claim 6 and further including:
using said customer processing device to choose a selected discount from said discount information.

8. The method as set forth in claim 6 wherein said discount information includes a plurality of different discounts available for said selected product, said method further including:
using said customer processing device to choose a selected discount from said plurality of different discounts.

9. The method as set forth in claim 7 and further including:
saving said selected discount information in a memory.

10. The method as set forth in claim 9 wherein said selected discount information is transmitted to a local server, said selected discount information being saved in memory in said local server.

11. The method as set forth in claim 9 wherein said selected discount information is saved in a memory within said customer processing device.

12. The method as set forth in claim 9 and further including:
associating customer identification information with said selected discount information in said memory.

13. The method as set forth in claim 12 and further including:
providing customer identifying information for identifying said customer at a checkout terminal; and
retrieving said selected product information and said discount information associated with said customer in response to receiving said customer identifying information at said checkout terminal.

14. The method as set forth in claim 13 and further including deducting selected discounts obtained from said selected discount information from charges otherwise applicable for said selected products at said checkout terminal.

15. The method as set forth in claim 14 and further including updating databases associated with said selected products, said updating being initiated at said checkout terminal.

16. The method as set forth in claim 1 wherein said products are offered for sale to said customers.

17. The method as set forth in claim 1 wherein said products are offered for license to said customers.

18. The method as set forth in claim 1 wherein said products are offered for lease to said customers.

19. A customer processing device comprising:
scanning means selectively operable to scan coded indicia and provide a scanned data output signal representative of said coded indicia;
means for transmitting said scanned data output signal to a server system, said server system being operable to transmit response information to said customer processing device in response to a receipt of said scanned data output signal;
means for receiving said response information by said customer processing device;
means for displaying said response information by said customer processing device.

20. The customer processing device as set forth in claim 19 and further including means for enabling a user to make a user selection from said displayed response information.

21. The customer processing device as set forth in claim 20 wherein said means for transmitting is further selectively operable to transmit information related to said user selection to said server system.

22. The customer processing device as set forth in claim 20 wherein said customer processing device further includes means for storing said user selection information.

23. The customer processing device as set forth in claim 22 wherein said customer processing device further includes means for selectively retrieving said user selection information.

24. A computer terminal in a store environment wherein products are offered to customers, said computer terminal comprising:
input means by which said customers are enabled to input product information related to a particular product into a computerized discount system coupled to said computer terminal;
transmitting means for transmitting said product information from said computer terminal to said computerized discount system, said computerized discount system being operable in response to a receipt of said product information from said computer terminal for providing discount information applicable to said product;
means for displaying said discount information at said computer terminal.

25. The computer terminal as set forth in claim 24 wherein said input means is selectively operable for enabling a user to select a preferred discount from said displayed discount information.

26. The computer terminal as set forth in claim 25 wherein said transmitting means is further selectively operable to transmit said preferred discount to a local server system.

27. The computer terminal as set forth in claim 26 wherein said preferred discount is stored at said local server system.

28. A memory device containing coded indicia, said coded indicia being selectively accessible for providing program signals for processing discounts to customers for products being offered to said customers, said program signals being selectively operable for enabling:
entering product information into a customer processing device, said product information being sufficient to identify a selected product;
transmitting said product information from said customer processing device to a server, said server being responsive to a receipt of said product information for determining discount information, said discount information being related to discounts which are available for said selected product; and
transmitting said discount information from said server to said customer processing device.

29. A computer system arranged for processing discounts to customers for products being offered to said customers, said computer system comprising:
means for storing a searchable product discount database;
means for receiving information identifying a particular product by a customer;
means for searching said product discount database to determine discount information applicable to said particular product;
means for transmitting said discount information for display on a customer device by which said customer may select a preferred discount from said discount information;
means for receiving information identifying said preferred discount from said customer device; and
means responsive to a request received from a checkout terminal for transmitting said preferred discount information to said checkout terminal.

30. The computer system as set forth in claim 29 and further including means for assigning charges to appropriate store and manufacturer accounts for the proper allocation of said preferred discount.
